(19) United States
(12) Patent Application Publication
(10) Pub. No.: US 2013/0024204 A1
(43) Pub. Date: Jan. 24, 2013

(54) WEB BASED ELECTRONIC CONTROLLED SUBSTANCE ORDERING SYSTEM

(71) Applicants: Penny Hendrix, Belton, TX (US); Daniel Volney, Temple, TX (US)

(72) Inventors: Penny Hendrix, Belton, TX (US); Daniel Volney, Temple, TX (US)

(21) Appl. No.: 12/698,881

(22) Filed: Feb. 2, 2010

Related U.S. Application Data
(60) Provisional application No. 61/149,367, filed on Feb. 3, 2009.

(51) Int. Cl. G06Q 30/06; G06Q 50/24

(52) U.S. Cl. 705/2; 705/26.25; 705/26.35

(57) ABSTRACT

A Controlled Substance (CS) ordering system that includes: 1) a client interface operable to be hosted on an Internet site, the client interface operable to receive an order for a controlled substance; 2) a first server operable to support the client interface and post a signed order to a second server; 3) the second server, the first server and the second server operable to communicate securely within a secure zone, the second server protected from external communications by the first server, the second server operable to perform signature validation functions, including checking a revocation list via the external agency validation server, and then securely posts the results back to the first server; 4) a secured database server wherein signed validated orders are posted for fulfillment and reporting; and 5) an interface with an external agency validation server, the second server operable to establish an LDAP connection to the external agency validation server.

### REFERENCES TO RELATED APPLICATIONS

The present U.S. Utility Patent Application also claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Application Ser. No. 61/149,367, entitled “PLATFORM AGNOSTIC ELECTRONIC CONTROLLED SUBSTANCE ORDERING SYSTEM,” (Attorney Docket No. UPISP001US), filed Feb. 3, 2009, pending.

### TECHNICAL FIELD OF THE INVENTION

The present disclosure relates generally to ordering systems, and more particularly, ordering systems associated with electronic controlled substance orders.

### BACKGROUND OF THE INVENTION

Numerous industry systems are used by manufacturers and distributors for transmission of their customer's orders electronically. These electronic ordering systems provide a more efficient manner of placing orders that may have previously been submitted by phone, fax, or mail. With electronic ordering, orders may be placed by the Internet using a structured system such as Electronic Data Interchange (EDI).

An EDI system enables businesses to exchange business documents—such as purchase orders, invoices, and order status updates—automatically and electronically, eliminating the need for manual processes.

Electronic ordering allows data to be sent and received 24 hours a day. Because electronic ordering allows business to continue outside the normal business day the turnaround time for a business transaction can be significantly reduced. Electronic ordering expands channels of communication and can lead to better working relationships.

However, when these transactions involve controlled substances such as narcotics, Drug Enforcement Agency (DEA) regulations require that the shipper verify the recipient's

Federal DEA Certificate and an authorization form signed by the recipient. Such systems have until recently been prohibited from electronically transmitting controlled substance orders without the order also being submitted on the DEA 222 Form.

### SUMMARY OF THE INVENTION

A DEA compliant controlled substance ordering system (CSOS) managed entirely in a Web environment. Embodiments of the present invention are directed to systems and methods that are further described in the following description and claims. Advantages and features of embodiments of the present invention may become apparent from the description, accompanying drawings and claims.

One embodiment of the present disclosure provides a controlled substance ordering system (CSOS). This ordering system may include a signer client interface, a receiver client interfere, one or more web servers, a database server, and a network interface associated with an external agency validation system. The signer client interface may be hosted on a first network or Internet site and accessible through a browser. This signer client interface may have security management and digital signing functions available therein. The security management functions may involve the use of PKI certificate management or other like proper security. The receiver client interface may also be hosted on a network or Web site and accessible through a second browser. Although not necessarily required the second browser may have security management and digital signing functions associated with it as well.

The one or more Web servers may support: the signer client interface and the receiver client interface; generation of orders for controlled substances; digital signature validation functions; secure communication of orders for controlled substances to one or more databases; and both the maintenance and reporting functions associated with individual or aggregated orders. The database server allows signed validated orders to be posted for storage fulfillment and reporting. The interface with an external agency validation system, which may include a validation server, may be made through a secure connection between one or more of the web servers and the validation system. The secure connection to the external agency validation system may be a lightweight directory access protocol (LDAP) connection or other like connection known to those having skill in the art.

Additional functions of the controlled substance ordering system may involve the management of relationships among signers and receivers as well as the generation of prescriptions for controlled substances which may further involve the generation of unique prescription documents and the proper maintenance and reporting functions of these prescriptions. Such maintenance and reporting functions may involve the storage fulfillment and reporting of properly signed and validated prescriptions.

In addition to a controlled substance ordering system, the embodiments of the present disclosure may be applied to medical records or like types of information. One embodiment provides medical records storage and retrieval system. This medical records storage and retrieval system may include a client interface, one or more Web servers, a database server, and a network interface with a validation system. The client interface may be hosted on a network site by the one or more Web servers. This client interface may have security and digital sign functions such as that discussed with reference to the controlled substance ordering system.

The one or more Web servers may: manage relationships among parties wishing to securely share access to medical records; generate, sign, and requests to post or retrieve medical records; perform digital signature validation functions; securely communicate medical records; and tracked these items such that proper maintenance and reporting functions on the medical records are made. The database located on one or more database servers may allows for the signed and validated medical records to be posted for storage and retrieval. An interface within the validation system and the one or more Web servers may establish a secure connection in order to validate any posting or request for medical records.

Yet another embodiment provides an information exchange system. This information exchange system may include the client interface, one or more web servers, one or more database servers, and a secure connection between the Web servers and a validation system. The web servers host a client interface in the form of network or website accessible through a browser. This client interface has security management and digital signature functions. The server may also manage relationship among parties wish to exchange information or records. These records may for example be private, classified, proprietary information, or other public and non-public information wherein it may be desirable to track access to and main control of the integrity of that information. This allows the records and records request to be securely communicated to a database server. Information requests may be generated and signed prior to the posting and retrieving of records. Additionally digital signature validation functions may be performed prior to posting or retrieving of records. The web server may also allow maintenance or recording functions associated with the information contained and the access to the records.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates recent improvements to the basic architecture (in FIG. 7) of the CSOS application provided by embodiments of the present disclosure;

FIG. 2 depicts the actual network configuration on which the CSOS application provided by embodiments of the present disclosure are hosted;

FIG. 3 shows that the various end users such as but not limited to Hospital 204 may provide orders to Pharmacy 202 (the original company for whom the embodiments of the present disclosure were created) by phone, fax, email or via a secure Web site;

FIG. 4 illustrates a controlled substance order being placed by Hospital 204 to Pharmacy 202;

FIG. 5 shows that prior to implementation of the embodiments of the present disclosure, the controlled substance order involved a manual process of filling out the DEA paper Form 222

FIG. 6 shows that DEA-approved embodiments of the present disclosure allow the manual paper process to be replaced with a digital certificate or signature so controlled substance orders are facilitated by a secure Web method;

FIG. 7 illustrates the original basic architecture for placing orders for controlled substances via the Web in accordance with embodiments of the present disclosure;

FIG. 8 illustrates recent improvements to the processes illustrated in the Data Flow Diagram in FIG. 12, depicting the information flow within the order processing system provided by embodiments of the present disclosure;

FIG. 9 provides details of the e222 Creation process in the Data Flow Diagram in FIG. 8 in accordance with embodiments of the present disclosure;

FIG. 10 provides details of the e222 Mgmt process in the Data Flow Diagram in FIG. 8 in accordance with the embodiments of the present disclosure;

FIG. 11 provides the original context level Data Flow diagram 700 that illustrates at the highest level how embodiments of the present disclosure may work;

FIG. 12 provides details of Data Flow Process 1 of FIG. 11, further illustrating the information flow within the order processing system provided by embodiments of the present disclosure;

FIG. 13 provides details of Data Flow Process 1.1 of FIG. 12, further illustrating how an online order is created in accordance with embodiments of the present disclosure;

FIG. 14 provides details of Data Flow Process 1.1.1 of FIG. 13, further illustrating the process of creating, signing, and validating an order in accordance with the embodiments of the present disclosure;

FIG. 15 provides details of Data Flow Process 1.1.3 of FIG. 14, further illustrating the interface between the new Web-based ordering system and the existing legacy order processing and fulfillment system in accordance with embodiments of the present disclosure;

FIG. 16 provides details of Data Flow Process 1.4 of FIG. 12, further illustrating the results of the automated reporting process in accordance with embodiments of the present disclosure;

FIG. 17 provides a screen shot of the login page of an online ordering system as provided by embodiments of the present disclosure;

FIG. 18 provides a screen shot of the available options to a user after the user has successfully logged in via the login page shown in FIG. 17;

FIG. 19 provides a screenshot within an online ordering system of a link to a feature for creating orders interactively in accordance with embodiments of the present disclosure;

FIG. 20 provides a screenshot of an online ordering system order being created interactively in accordance with embodiments of the present disclosure;

FIG. 21 provides a screenshot of the final order disposition page from which the signer elects to transmit the order to the receiver in accordance with embodiments of the present disclosure;

FIG. 22 provides a screenshot wherein a popup 1902 is used to show a list of locally installed digital certificates from which the signer selects one to be used to sign the order in accordance with embodiments of the present disclosure;

FIG. 23 provides a screenshot of the signer's Web browser requesting the signer to enter a password allowing the locally installed digital certificate to be used to digitally sign the order in accordance with embodiments of the present disclosure;

FIG. 24 provides a screenshot of the results of the digital signature validation process and preliminary order confirmation in accordance with embodiments of the present disclosure;

FIG. 25 provides a screenshot of the order confirmation in the form of an electronic Form 222 produced by system in accordance with embodiments of the present disclosure; and

FIG. 26 provides a screenshot detailing the automated response from external agency reporting system in accordance with embodiments of the present disclosure.

### DESCRIPTION OF THE INVENTION

Embodiments of the present invention are illustrated in the FIGs., like numerals being used to refer to like and corresponding parts of the various drawings.

Embodiments of the present invention provide Electronic controlled substance (CS) orders be placed using software programs that have been approved as controlled substance ordering systems (CSOS). Typically, this software is implemented in a controlled substance supplier's location. This software includes functionality to digitally sign the purchase order using the purchaser's CSOS digital certificate issued by the Drug Enforcement Agency (DEA). A CSOS Certificate may be installed into multiple software programs and may be transferred to multiple ordering computers.

The DEA's CSOS program allows for secure electronic controlled substance orders without the supporting paper DEA Form 222. Using a technology called PKI, CSOS requires that each individual purchaser enroll with DEA to acquire a CSOS digital certificate.

PKI is a technology that allows for secure on-line business transactions. With PKI, a trusted Certification Authority (CA) issues digital certificates to subscribers after validating their identity and authority. With CSOS, subscribers use these certificates to digitally sign controlled substance orders that are placed using CSOS-enabled ordering software. PKI technology provides the following security services to an electronic ordering system:
(1) Confidentiality—only authorized persons have access to data
(2) Authentication—establishes who is sending/receiving data
(3) Integrity—the data has not been altered in transmission
(4) Non-repudiation—parties to a transaction cannot convincingly deny having participated in the transaction

The CSOS process involves: 1. An individual enrolls with DEA and, once approved, is issued a personal CSOS Certificate; 2. The purchaser creates an electronic 222 order using approved ordering software. The order is digitally signed using the purchaser's personal CSOS Certificate and then transmitted to the supplier. The paper Form 222 is not required for electronic ordering. 3. The supplier receives the purchase order and verifies that the purchaser's certificate is valid with DEA. Additionally, the supplier validates the electronic order information just like a paper order. 4. The supplier completes the order and ships to the purchaser. Any communications regarding the order are sent electronically. 5. The order is reported by the supplier to DEA within a predetermined period of time.

Prior embodiments of controlled electronic controlled substance reporting systems are typically part of a larger overall framework of Business-to-Business (B2B) applications. These systems do not provide a stand-alone single-source application capable of operating agnostically with various computing platforms. Further, these existing systems require the installation of various unique software modules on the signer system, and require hardware and various unique software modules in the receiver infrastructure in order to support the electronic transactions associated with controlled substances.

Embodiments of the present disclosure provide a Web-based electronic system associated with creating, signing, validating, tracking, and reporting electronic orders associated with controlled substances. This system may be agnostic to users wherein specific hardware requirements and installation of software modules is not required by either the signer or the receiver. Rather both signers and receivers may access this electronic CSOS processing system via a Web browser and through the use of a digital certificate that may be stored independently in the user's Web browser.

Embodiments of the present invention provide an architecture where controlled substance order functions are implemented using the existing Internet infrastructure. This solution evolved out of a need for an alternative to existing commercially available Controlled Substance Ordering System (CSOS) software that would be simpler to implement and less intrusive into both the signer's and the receiver's existing IT environment. If suppliers (receivers of controlled substance orders and paper Forms 222) can not or will not implement existing commercially available CSOS software, then the CSOS initiative is of no use to the pharmaceutical industry supply chain or the Drug Enforcement Administration (DEA).

One embodiment simplifies transactions for the buyer. Another simplifies transactions for the supplier. A third embodiment simplifies transactions for DEA and helps the DEA to meet their long-term goals for CSOS.

In a first embodiment, the CSOS software has been implemented for a single supplier with multiple buyers. The software was designed to use an Internet Explorer browser as the buyer's software so that no proprietary software would have to be built and installed on the buyer's computer. This allows the tens of thousands of buyers not on CSOS, whom DEA would like to see using CSOS, to more easily implement and use CSOS.

In a second embodiment, the CSOS software architecture has been modified to allow the supplier functions to be executed on a remotely located server that is leased by the supplier, instead of on a server owned by the supplier and physically located at that supplier's premises. The purpose of this arrangement is to destroy the impression that a physical barrier is required to keep one supplier's information separate from another's. This step is important to CSOS becoming widely adopted, as most small suppliers do not have the capability of running their own highly secure Web server.

In such an embodiment, each supplier's copy of the CSOS software may be deployed on a separate virtual server (within one or more physical server(s)). These may be located for example within a Tier One data center.

In a third embodiment, the CSOS software architecture has been modified to a single-source “software as a service” model.

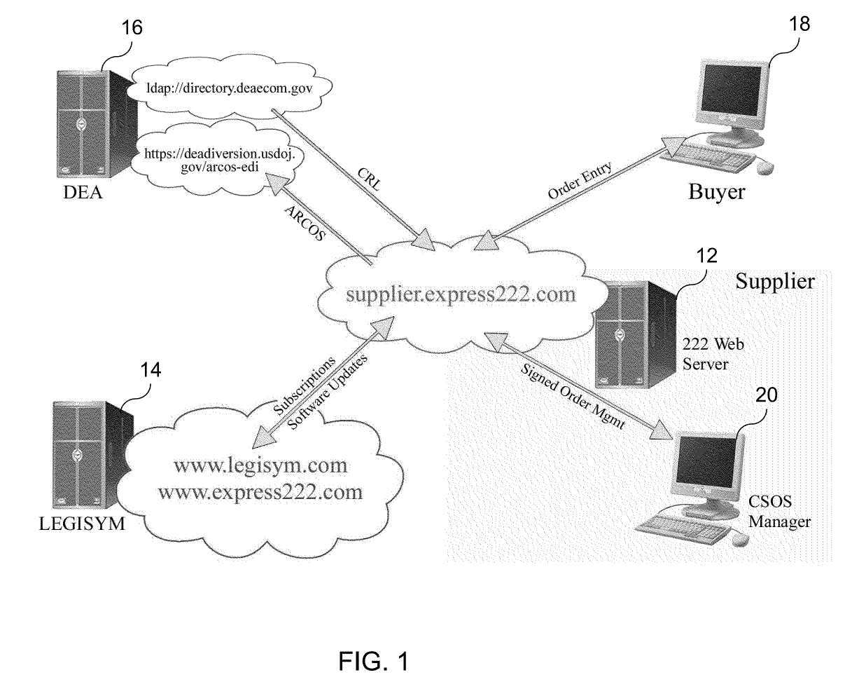

FIG. 1 illustrates one embodiment of the basic architecture of the CSOS application provided by embodiments of the present disclosure. This architecture includes a network based server 12, system server 14 and DEA server 16. These servers may use a cloud computing model or architecture to present an order entry interface 18 to ordering network attached users and a controlled substance ordering system management interface 20 to managing network attached users.

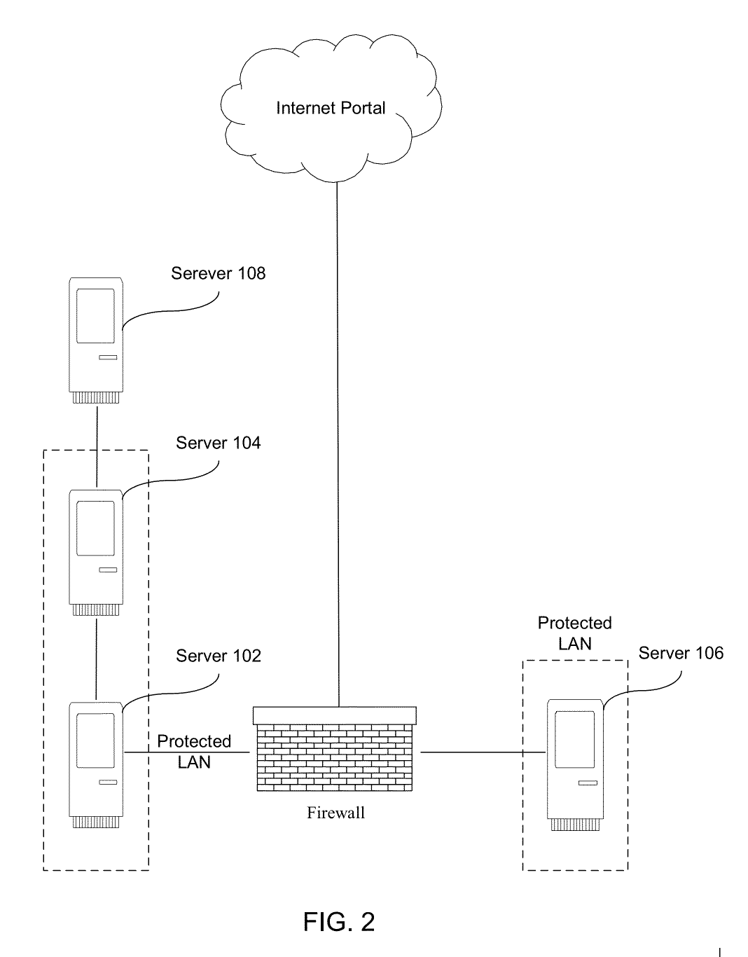

FIG. 2 illustrates the basic architecture of the CSOS application provided by embodiments of the present disclosure. Here the CSOS application is divided into three parts: 1) The client interface, which is part of the provider Web site, may run on server 102 such as an Apache Web server. This part of the application in one embodiment may be written in primarily PHP, with some JavaScript; 2) The digital signature validation functions run on a highly secured server 104 such as an IIS server. This part of the application in one embodiment may be written in .NET; and 3) The database runs on a separate highly secured server 106, with pinhole access only from the first server. Server 102 and server 104 communicate inside the DMZ. Server 104 is shut off from the outside world except for an LDAP connection to the DEA server 108 for accessing revocation lists. Server 106 is inside the LAN, protected from the DMZ.

The online order entry pages are available only to clients who are already known and have been issued a username and password. Passwords are stored in the database as hashed values and are unknown to anyone except the client. Once a client logs in, his information is stored using PHP sessions to allow him to navigate among the secure pages on the site. These private pages are protected by a VeriSign Extended Validation SSL certificate.

When a client creates an order on the Web site, the order details may be stored in the database in normalized format as well as in xml format. When the client is ready to submit the order, if the order contains controlled substance the client is given the option of submitting a paper DEA form 222 or signing the order using a PKI x.509 certificate. If the client opts to sign the order with a PKI certificate, the xml order is written to a temporary table in the database, and he is redirected to another page on Server 102 that displays the complete order and issues a request for him to choose a certificate from his certificate store to sign the xml copy of the order. The request is issued via JavaScript commands invoking standard cryptographic functions resident on the client's computer.

If the client chooses a certificate and completes the signing process, the signed order is placed in a form on that page, and is then posted to server 104 to perform signature validation functions, including checking the revocation list, and then securely posts the results back to Server 102, which displays the results to the client.

If the signed order passes all the validation checks, both the xml copy of the order and the signed copy of the order are stored in the database. A process running on Server 106 pulls the xml copy of the order to be processed by the order processing software in the legacy order processing and fulfillment system.

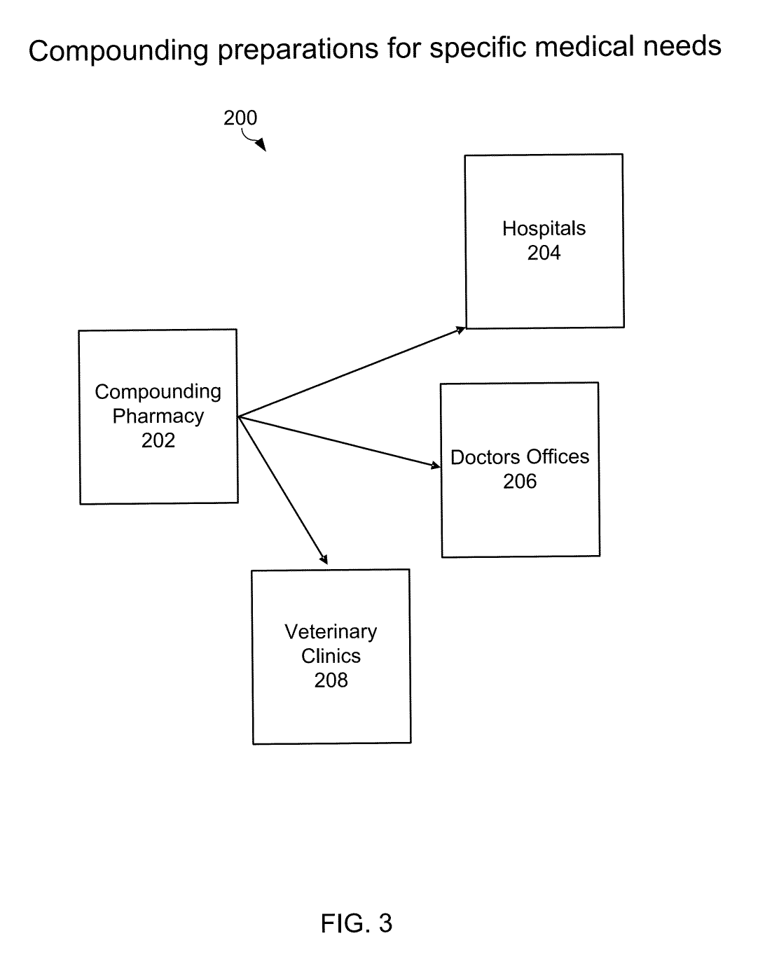

FIG. 3 provides a block diagram showing the customers that may be associated with a compounding pharmacy that may provide controlled substances to various users. For example, Compounding Pharmacy 202 may supply compounded pharmaceuticals that may include controlled substances to Hospitals 204, Doctors' Offices 206, and the veterinary Clinics 208.

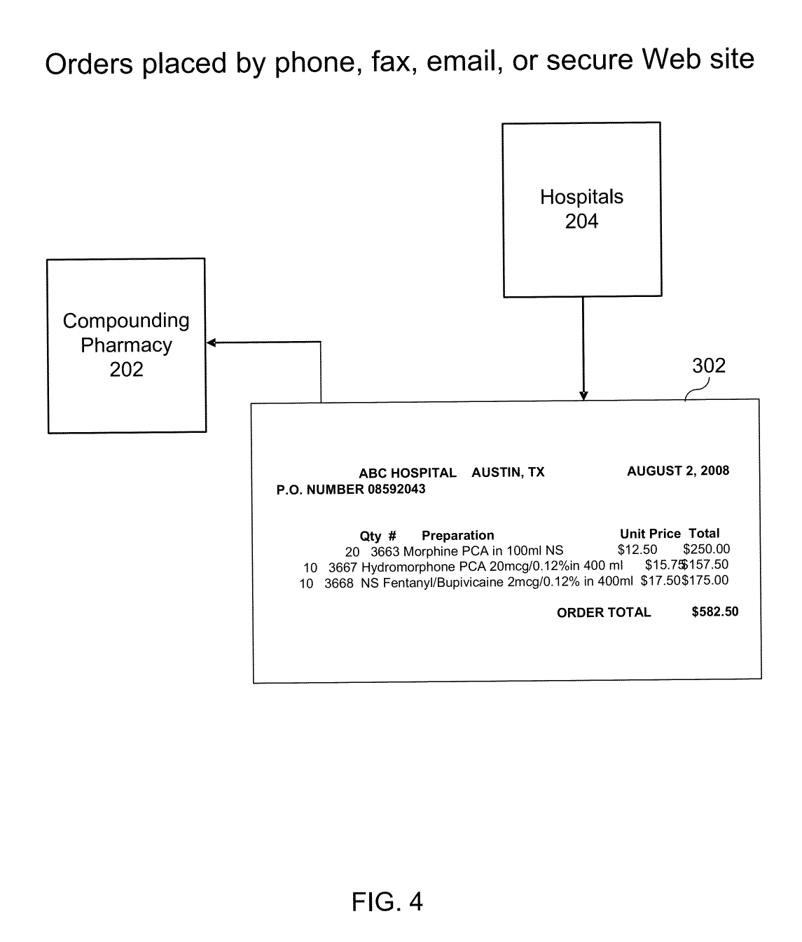

FIG. 4 shows that the various end users such as but not limited to Hospital 204 may provide orders 302 to Pharmacy 202 by phone, fax, email or via a secure web site.

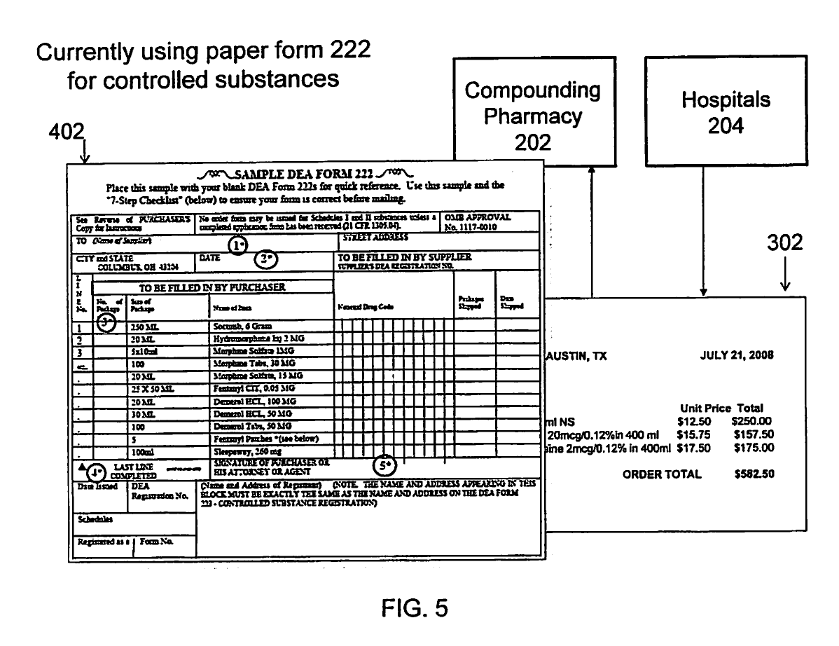

FIG. 5 provides a block diagram similar to that of FIG. 3. However in this case, where the orders 302 for pharmaceuticals requested and provided are controlled substances, current guidelines from the DEA require a Form 222 402 be associated with the controlled substance transactions. Form 222 402 is currently physically delivered to the pharmacy prior to the order fulfillment.

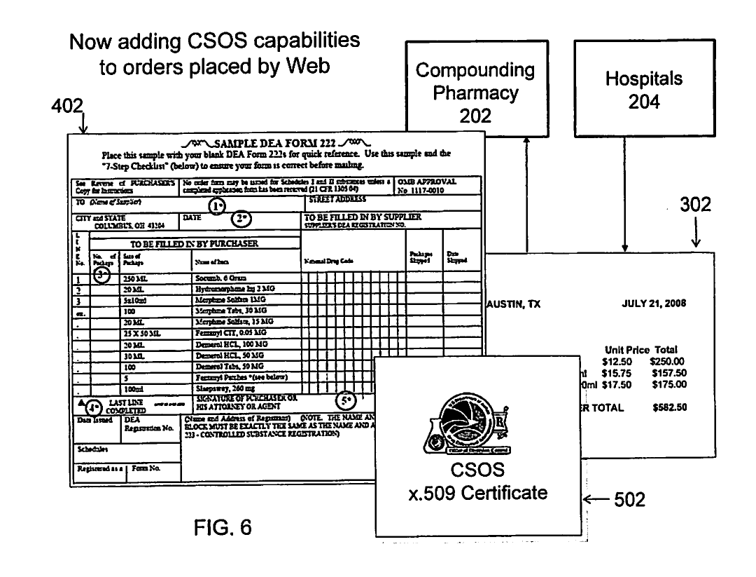

FIG. 6 shows that embodiments of the present disclosure add a digital certificate 502 or signature that adds new order and tracking capabilities and allows orders to be facilitated by a secure web method in accordance with embodiments of the present disclosure.

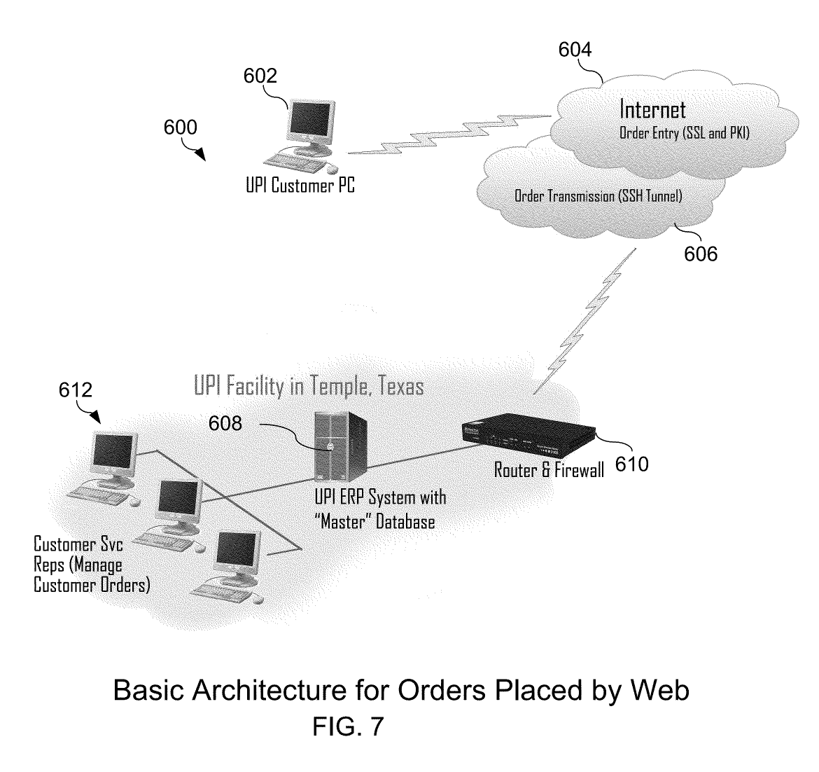

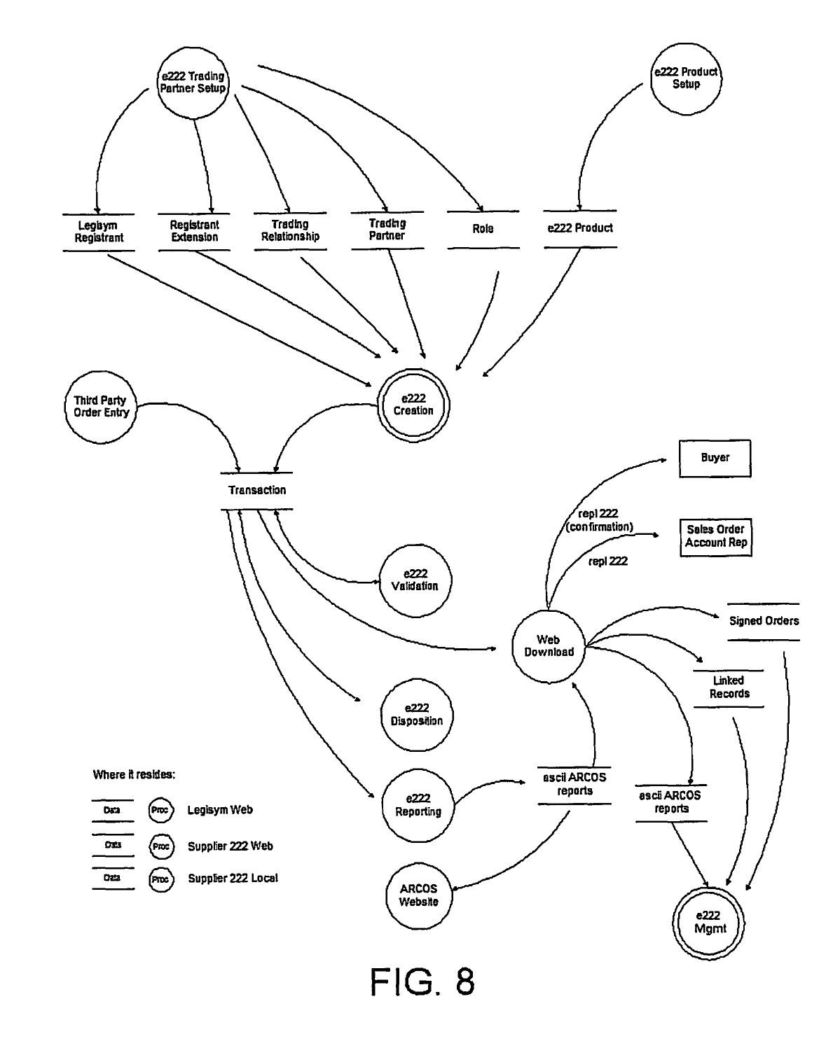

FIG. 7 describes the basic architecture for placing orders for controlled substances over the web in accordance with embodiments of the present disclosure. Basic Architecture 600 includes a customer or client PC 602 network such as Internet 604 and Secure Tunnel 606 for order transmission to a local server 608, which may be protected by optional firewall and Router 610. Customer service and customer representatives operable 612 are able to manage customer orders received securely over the Internet using a public key infrastructure to allow a digital signature to be transmitted securely to the compounding pharmacy's facility for order fulfillment. Using a browser on the client or customer PC 602 allows the client or customer to securely interact and place these drug or pharmaceutical orders without the need for special software to be installed locally on their computers. Only an internet browser is required

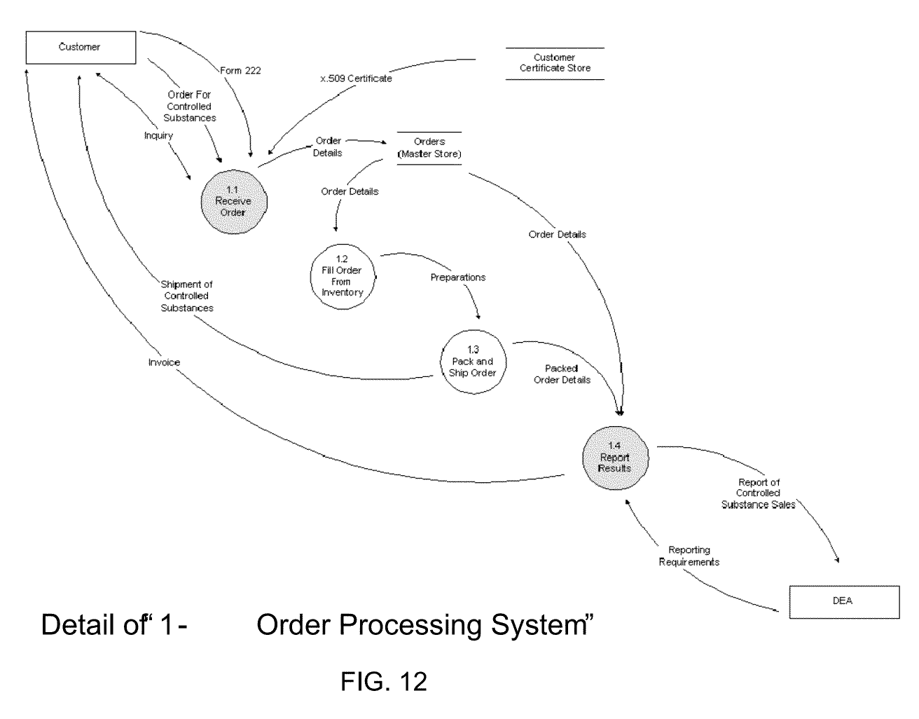

FIG. 8 provides a context diagram 800 that provides a highest level diagram of how embodiments of the present disclosure may work. FIG. 8 illustrates one embodiment of the present disclosure improvements to the processes illustrated in the Data Flow Diagram in FIG. 12, depicting the information flow within the order processing system provided by embodiments of the present disclosure. This data flow diagram shows that data flows from the customer to the system and back as well as from the system to the DEA and back. These orders may be cross-referenced against certificates, which may have been revoked in order to ensure that improper orders using improper, expired, or revoked certificates are not processed. Information received from the customer, as well as a stored certificate from the customer, may be cross-referenced against a controlled substance certificate revocation list, wherein the order processing system verifies the validity of the certificates and the order prior to order fulfillment and facilitates the report of controlled substance sales to an external agency such as the DEA.

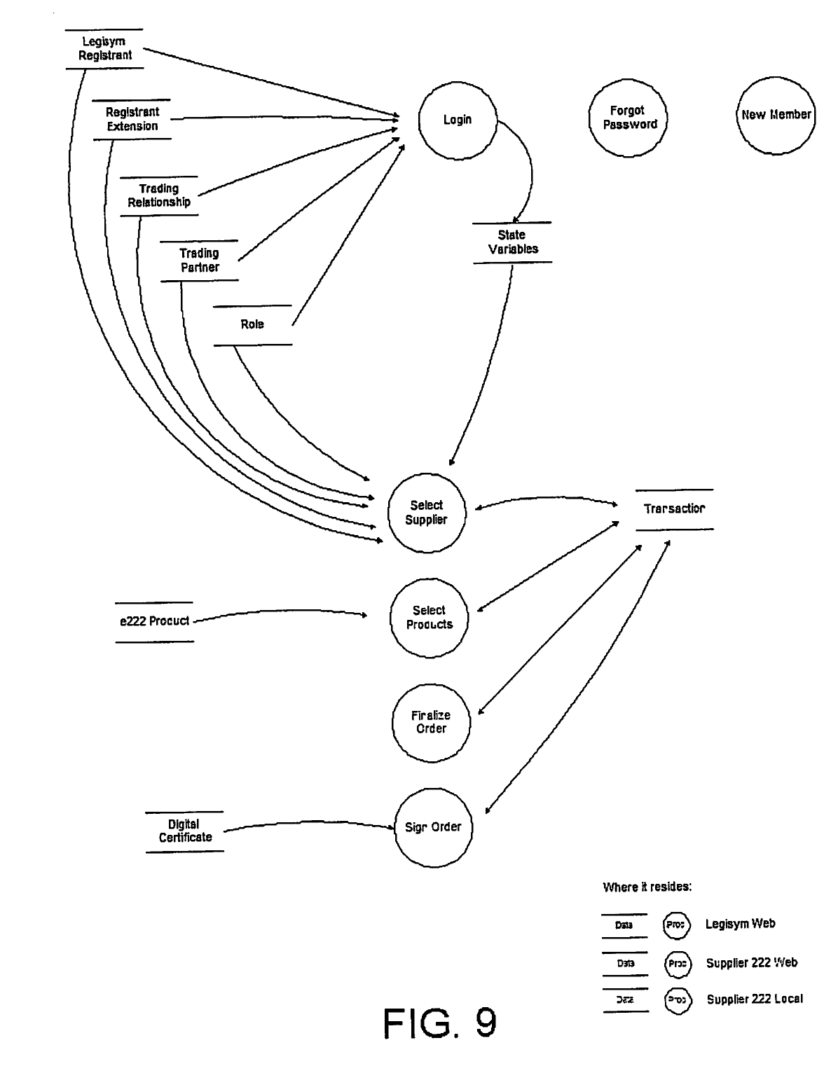

FIG. 9 provides details of the e222 Creation process in the Data Flow Diagram in FIG. 8 in accordance with embodiments of the present disclosure.

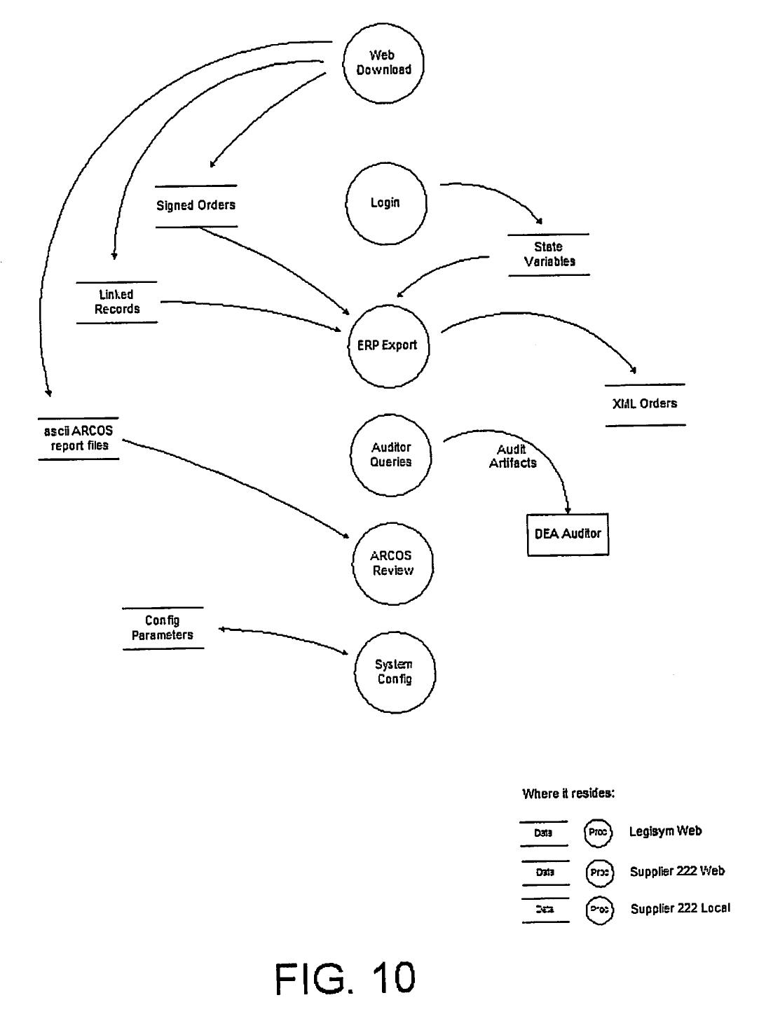

FIG. 10 provides details of the e222 Mgmt process in the Data Flow Diagram in FIG. 8 in accordance with the embodiments of the present disclosure.

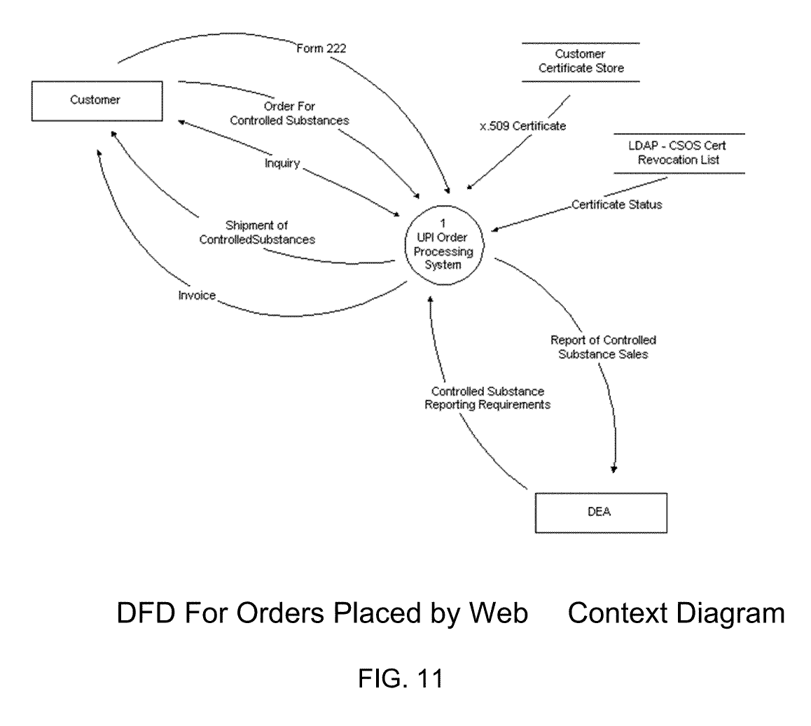

FIG. 11 provides a context diagram 1100 that provides a highest level diagram of how embodiments of the present disclosure may work. FIG. 11 depicts the information flow within the order processing system provided by embodiments of the present disclosure. This data flow diagram shows that data flows from the customer to the system and back as well as from the system to the DEA and back. These orders may be cross-referenced against certificates, which may have been revoked in order to ensure that improper orders using improper, expired, or revoked certificates are not processed. Information received from the customer, as well as a stored certificate from the customer, may be cross-referenced against a controlled substance certificate revocation list, wherein the order processing system verifies the validity of the certificates and the order prior to order fulfillment and facilitates the report of controlled substance sales to an external agency such as the DEA.

FIG. 12 provides details of Data Flow Process 1 of FIG. 11, further illustrating the information flow within the order processing system provided by embodiments of the present disclosure. FIG. 12 shows that the order processing system consists of four basic processes, Process 1.1 where an order is received, Process 1.2 where an order is filled from inventory, Process 1.3 where an order is packed and shipped, and Process 1.4 where the order details are reported to the external agency. The Process 1.1 and Process 1.4 are primarily involved in the controlled substance certification and reporting.

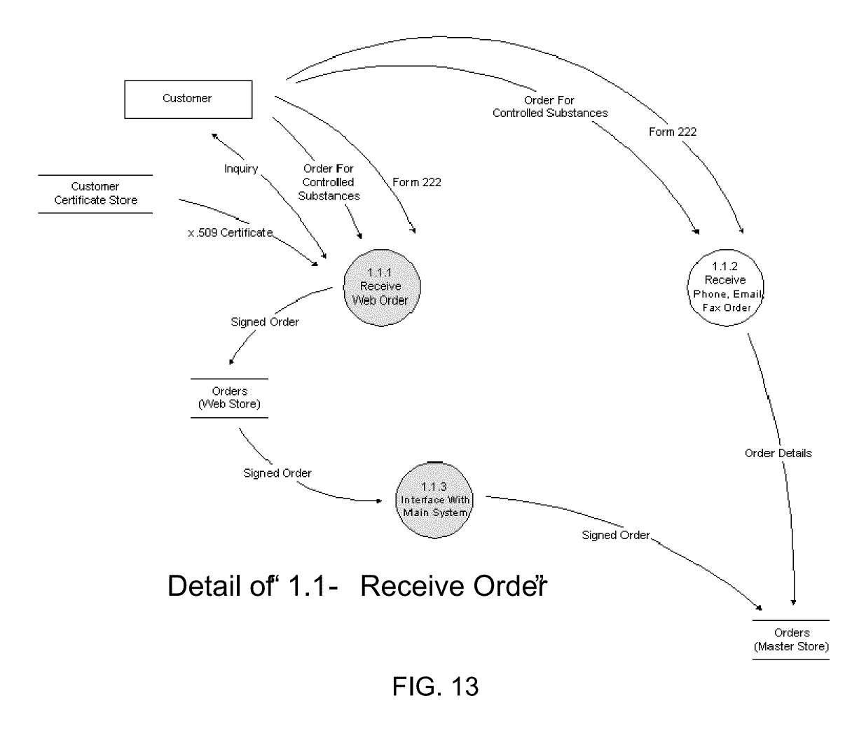

FIG. 13 provides details of Data Flow Process 1.1 of FIG. 12, further illustrating how an online order is created in accordance with embodiments of the present disclosure. As shown, here the orders may be received via a secure link over the web, or in more traditional means, via phone, email, or fax orders. The web order along with a digital certificate allows an electronic Form 222 and an electronic order for controlled substances to be securely received and digitally signed for in order that the order may be properly processed.

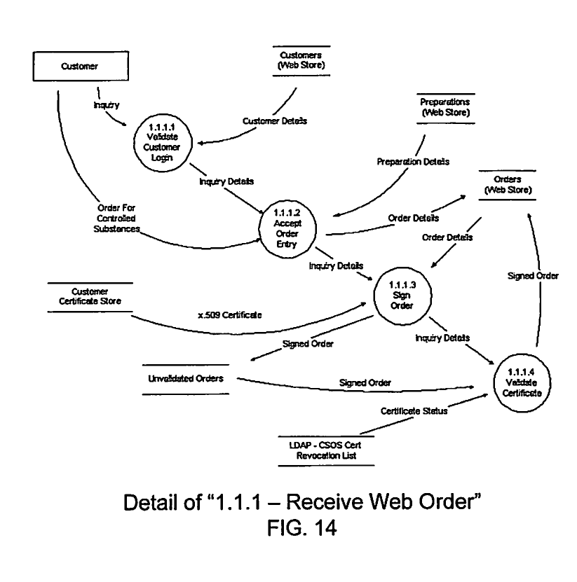

FIG. 14 provides details of Data Flow Process 1.1.1 of FIG. 13, further illustrating the process of creating, signing, and validating an order in accordance with the embodiments of the present disclosure. This data flow diagram further details the process of receiving an electronic or web-based order for pharmaceuticals including those ordered for controlled substances. A customer logs into the site and is validated in Step 1.1.1.1. They navigate to a web page or a browser window in order to enter an order as indicated by the accept order entry Data Point 1.1.1.2. The order may be identified as an order for controlled substances from the customer as shown based on the kinds of items that are ordered. If the order is for a controlled substance, clients have the ability to use a digital certificate in order to sign the order as indicated at Data Point 1.1.1.3. This signed order may be stored in the database as an un-validated order, which may be further processed. The signed order is then validated at Data Point 1.1.1.4 where the validation module verifies the controlled substance certificate with the DEA Agency database to ensure that the certificate status is in good standing. Additionally other administrative checks may be performed on the certificate to ensure it is proper. The signed order may then go into the order's database.

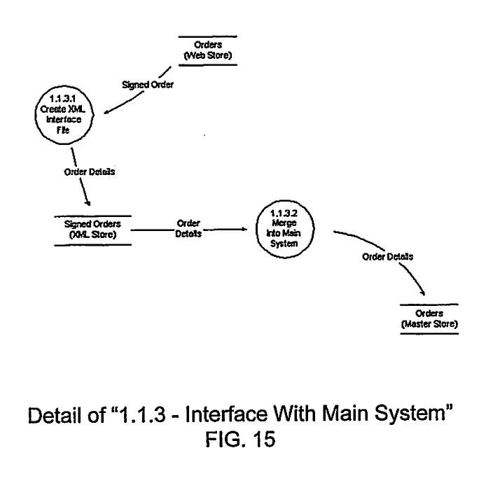

FIG. 15 provides details of Data Flow Process 1.1.3 of FIG. 14, further illustrating the interface between the new Web-based ordering system and the existing legacy order processing and fulfillment system in accordance with the embodiments of the present disclosure. This is after the signing and validation of the actual order. The signed order is then provided to an interface file via a web interface. This data is merged with all the orders in the main system for processing where it is merged into the master order database.

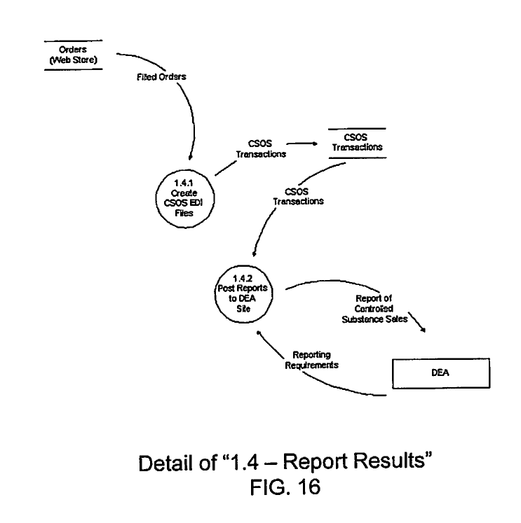

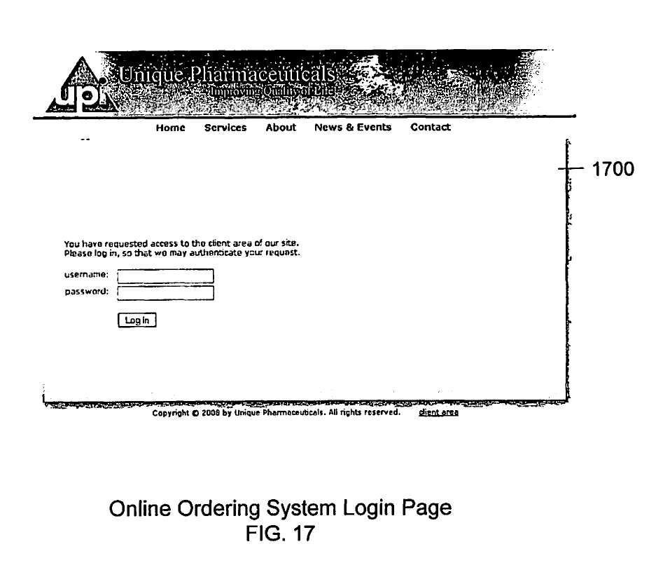

FIG. 16 provides details of Data Flow Process 1.4 of FIG. 12, further illustrating the results of the automated reporting process in accordance with embodiments of the present disclosure. Data Point 1.4 deals with the reporting of results. The orders that are to be reported in one example may be those associated with controlled substance digital certificate files. Electronic orders for controlled substances that are associated with the secured electronic transactions, these controlled substance transactions are identified within a controlled substance transaction database and then these transactions may be posted as reports to the agency site. As shown, here the agency may specify reporting requirements that may change over time in order to improve the quality of the report of controlled substance sales. This is a completely automated process where the transactions are formatted and sent to the DEA.

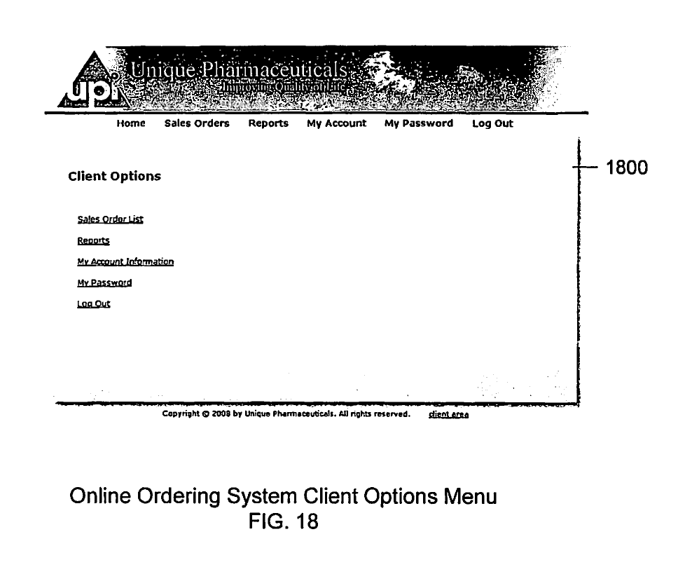

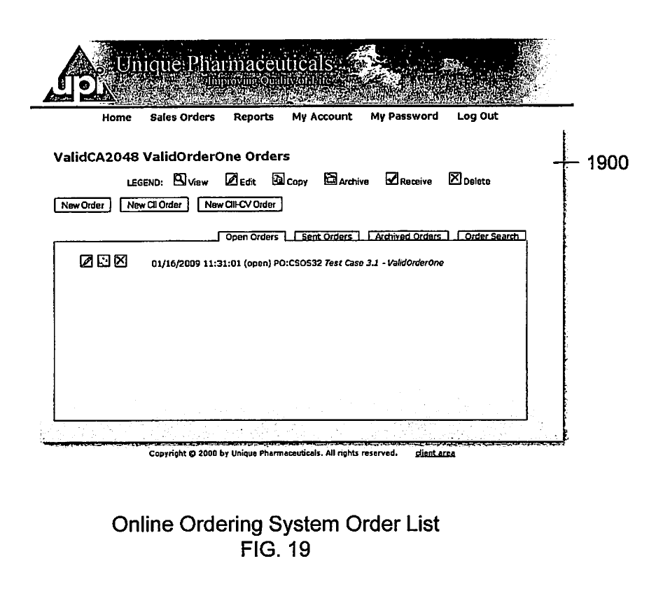

FIG. 17 provides a screen shot of the login page of an online ordering system as provided by embodiments of the present disclosure. The user through their browser may log on to an online ordering system via Login Page 1700. After logging in the user may see various available options. FIG. 18 provides a screen shot of the available options to a user after the user has successfully logged in via the login page shown in FIG. 17 as provided by embodiments of the present disclosure. In this embodiment Page 1800 presents first a sales order list followed by reports, my account information, my password, and log out. The sales order list may be described further with respect to FIG. 19.

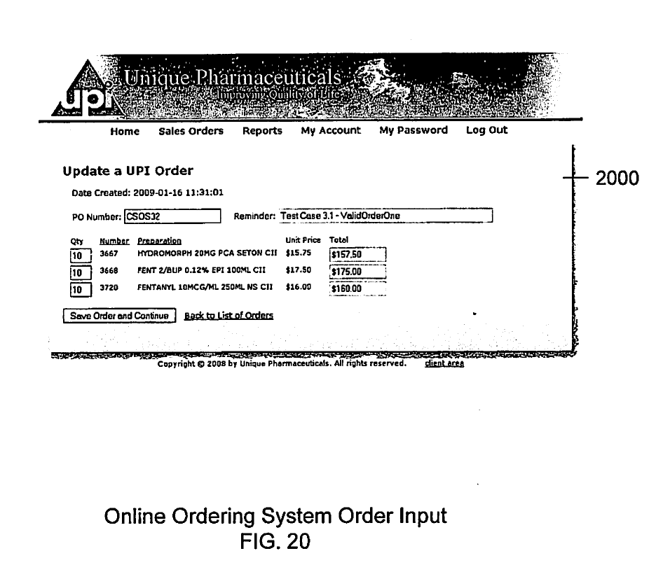

FIG. 19 provides a screenshot 1900 within an online ordering system of a link to a feature for creating orders interactively in accordance with embodiments of the present disclosure. screenshot 1900 shows specifically an open order has several tabs that include open order, sent orders, archive orders, and order search. screenshot 1900 shows the open orders where an order pocsos32 is in the process of being submitted. If one were to click on the open order, the details of that order would be provided in FIG. 20.

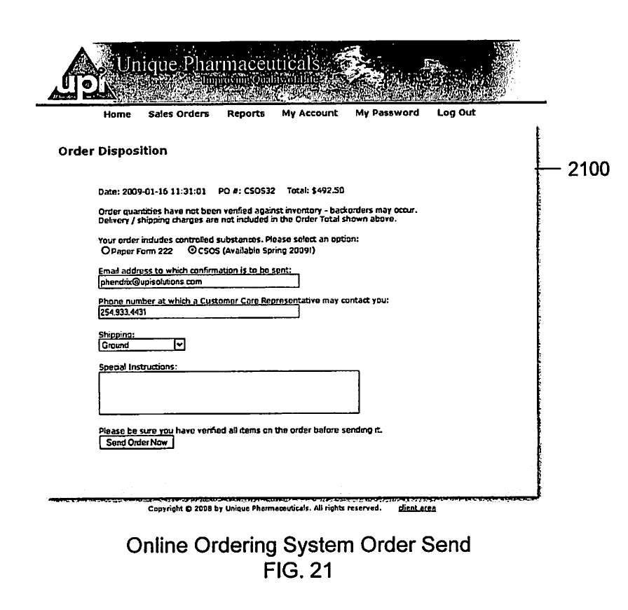

FIG. 20 provides a screenshot 2000 of an online ordering system order being created interactively in accordance with embodiments of the present disclosure. screenshot 2000 provides the details of this order. This order consists of three control substances and an associated quantity. If the user were to click on the same order and continue button of FIG. 20 the screen shot of FIG. 21 would be presented.

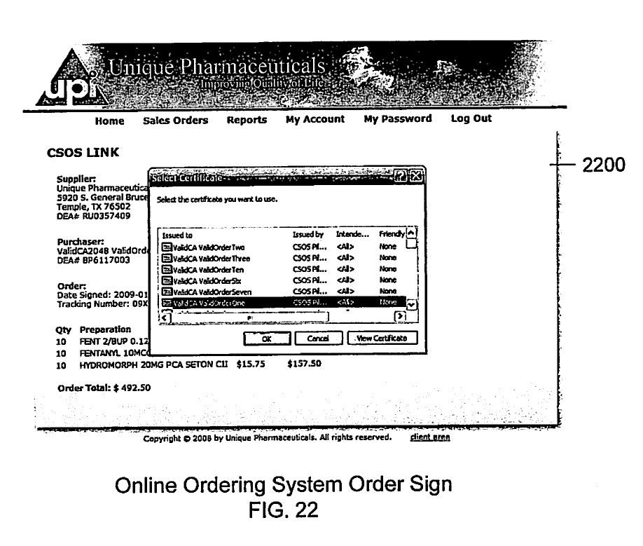

FIG. 21 provides a screenshot 2100 of the final order disposition page from which the signer elects to transmit the order to the receiver in accordance with embodiments of the present disclosure. Here, a user has the option to choose either a traditional paper Form 222 or an electronic version of Form 222 for controlled substances. If they chose the electronic CSOS option and then choose the “send order now” button the screenshot 2200 associated with FIG. 22 will be presented.

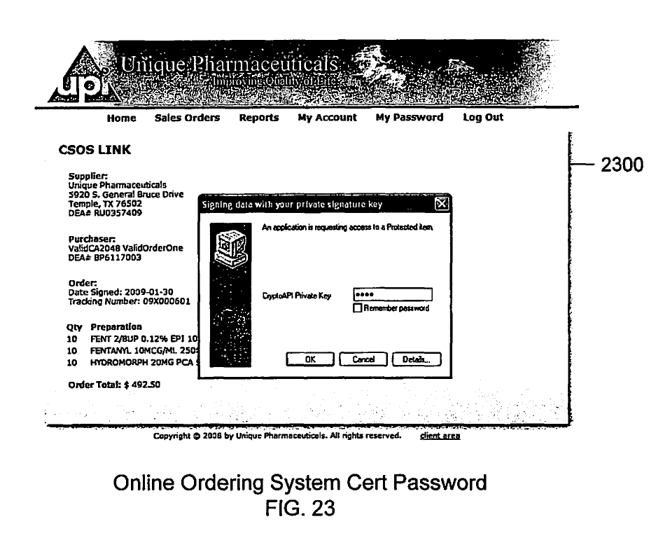

FIG. 22 provides a screenshot 2200 wherein a popup 2202 is used to show a list of locally installed digital certificates from which the signer selects one to be used to sign the order in accordance with embodiments of the present disclosure. screenshot 2200 behind the Popup Box 2202 are all the details associated with the controlled substance order. The popup box allows a digital certificate to be associated with the order and used to sign the order. This is the information that is required to verify the order. The popup box allows them to choose any of the digital certificates that they have installed within their system on which the browser is operating. When the user selects okay after selecting the appropriate digital certificate an online ordering system certification password is requested as shown in FIG. 23.

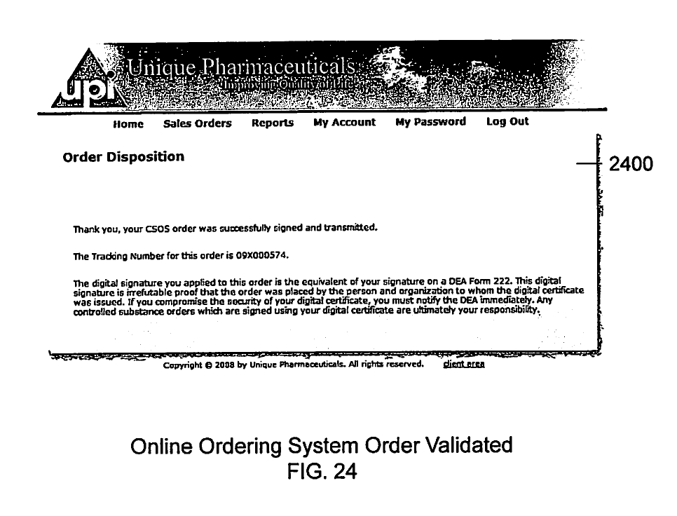

FIG. 23 provides a screenshot 2300 wherein a popup 2302 requests the signer to enter a password allowing the locally installed digital certificate to be used to digitally sign the order in accordance with embodiments of the present disclosure. Popup 2302 allows a user to digitally sign an order for controlled substances. Behind popup Box 2302 are the details of the controlled substance order. When the proper password is submitted and the digital certificate is validated a screenshot such as that provided by FIG. 24 may be presented.

FIG. 24 provides a screenshot 2400 of the results of the digital signature validation process and preliminary order confirmation in accordance with embodiments of the present disclosure. Screenshot 2400 shows an online order being validated. This screenshot tells the user the status of the order wherein the controlled substance order was successfully signed and transmitted and a tracking number is associated with it. Further details associated with the electronic DEA Form 222 may be provided.

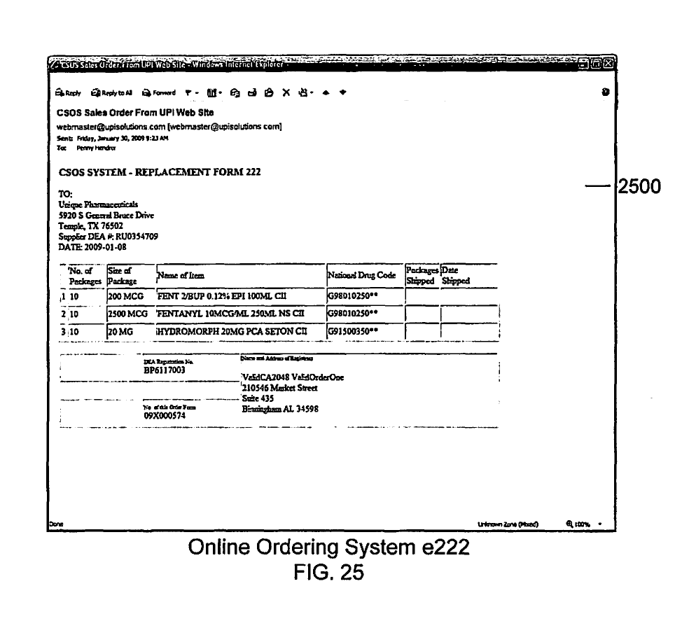

FIG. 25 provides a screenshot 2500 of the order confirmation in the form of an electronic Form 222 produced by system in accordance with embodiments of the present disclosure. Electronic Form 222 may be provided to supplement the electronic tracking of the controlled substances with paper tracking if needed. This allows the shipping personnel within a pharmacy handling controlled substances to know that this particular order can be fulfilled.

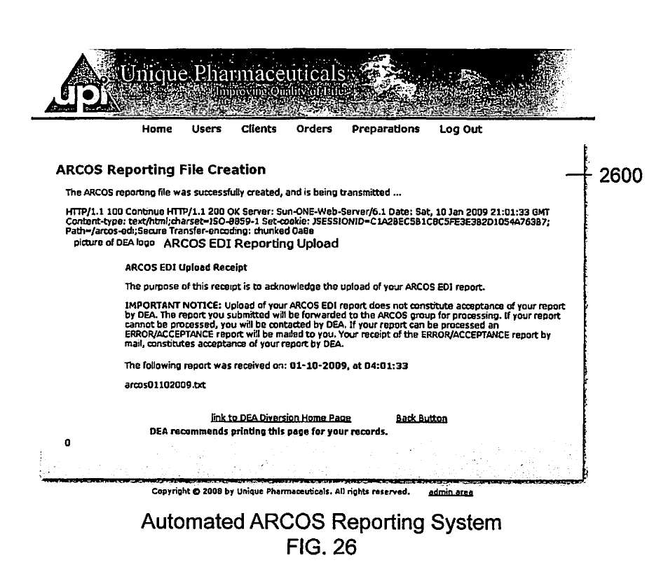

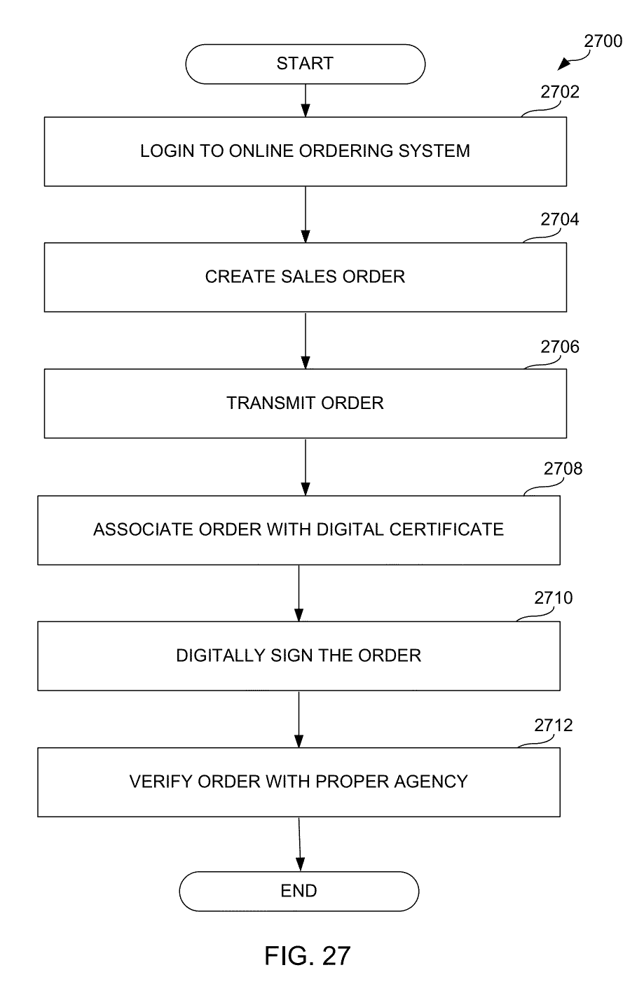

FIG. 26 provides a screenshot 2600 detailing the automated response from external agency reporting system in accordance with embodiments of the present disclosure. This automated report may be periodically uploaded as required by the agency reporting requirements.

This report may be automatically generated and reported to the agency and a confirmation of this report may be provided by this automated report file creation screenshot

FIG. 27 provides a logic flow diagram associated with the process of placing an order for a controlled substance in accordance with embodiments of the present disclosure. Operations 2700 begin in Block 2702 wherein a user may log on to a network site be in the interface such as that discussed with reference to FIGS. 17 and 18. In Block 2704, after the user has logged on the user may create a sales order for a controlled substance or in other embodiments; this order may be for medical records or other proprietary information. Block 2704 relates to FIGS. 19 and 20 wherein a user may interactively create an order for controlled substances or information. In Block 2706 a user may transmit the order which when the order is transmitted a digital certificate may be selected to be associated with the order and Block 2708. At the same time, the order may be digitally signed in Block 2710. Then the order with the proper digital certificate and signature may be transmitted to a verifying agency where the order may be verified in Block 2712. Only a properly verified order may be executed.

The data flow charts, logic flow diagrams, screen shots, and block diagrams in the FIGs. illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the FIGs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times, code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In summary, embodiments of the present disclosure provide a Controlled Substance (CS) ordering system that includes: 1) a client interface operable to be hosted on an Internet site, the client interface operable to receive an order for a controlled substance; 2) a first server operable to support the client interface and post a signed order to a second server; 3) the second server, the first server and the second server operable to communicate securely within a secure zone, the second server protected from external communications by the first server, the second server operable to perform signature validation functions, including checking a revocation list via the external agency validation server, and then securely posts the results back to the first server; 4) a secured database server wherein signed validated orders are posted for fulfillment and reporting; and 5) an interface with an external agency validation server, the second server operable to establish an LDAP connection to the external agency validation server.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled.” As one of average skill in the art will further appreciate, the term “compares favorably,” as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

1. A Controlled Substance (CS) ordering system, comprising:
a signer client interface hosted on a first network site and accessible through a first browser, the signer client interface having security management and digital signing functions;
a receiver client interface hosted a second network site and accessible through a second browser;
at least one first server operable to:
support the signer client interface and the receiver client interface;
generate orders for controlled substance;
perform digital signature validation functions, including checking a revocation list via an external validation server;
securely communicate the orders for controlled substances to at least one database server; and
perform maintenance and reporting functions on the orders for controlled substances;
the database server wherein signed validated orders are posted for storage, fulfillment, and reporting; and
an interface with an external agency validation server, the at least one first server operable to establish a secure connection to the external agency validation server.

2. The controlled substance ordering system of claim 1, wherein the signer client interface supports PKI certificate management and digital signing functions.

3. The controlled substance ordering system of claim 1, wherein the secure connection to the external agency validation server is a Lightweight Directory Access Protocol (LDAP) connection.

4. The controlled substance ordering system of claim 1, wherein the first browser and the second browser comprise a Web browser.

5. The controlled substance ordering system of claim 1, wherein the secure connection between the external agency validation server and the at least one first server comprises a pinhole access connection.

6. The controlled substance ordering system of claim 1, wherein the at least one first server is further operable to:
manage relationships among signers and receivers; generate prescriptions for controlled substances;
generate a unique prescription document; and
perform maintenance and reporting functions on the prescriptions for controlled substances.

7. The controlled substance ordering system of claim 6, wherein signed validated prescriptions are posted for storage, fulfillment, and reporting to the at least one database server.

8. The controlled substance ordering system of claim 1, the receiver client interface having security management and digital signing functions.

9. A medical records storage and retrieval system, comprising:
a client interface hosted on a first network site and accessible through a first browser, the signer client interface having security management and digital signing functions;
at least one server operable to:
support the client interface;
manage relationships among parties wishing to securely share access to medical records;
generate signed requests to post or retrieve medical records;
perform digital signature validation functions, including checking a revocation list via an external agency validation server;
securely communicate the medical records and requests to a database server, and
perform maintenance and reporting functions on the medical records;
the database server wherein signed and validated medical records are posted for storage and retrieval; and
an interface with an external agency validation server, the at least one server operable to establish a secure connection to the external agency validation server.

10. The medical records storage and retrieval system of claim 9, wherein the signer client interface supports PKI certificate management and digital signing functions.

11. The medical records storage and retrieval system of claim 9, wherein the secure connection to the external agency validation server is a Lightweight Directory Access Protocol (LDAP) connection.

12. The medical records storage and retrieval system of claim 9, wherein the first browser comprises a Web browser.

13. The medical records storage and retrieval system of claim 9, wherein the secure connection between the external agency validation server and the at least one first server comprises a pinhole access connection.

14. An information exchange system, comprising:
a client interface hosted on a first network site and accessible through a first browser, the signer client interface having security management and digital signing functions;
at least one server operable to:
support the client interface;
manage relationships among parties wishing to exchange records, the records comprising private, classified, or proprietary information;
securely communicate the records and requests to a database server; and
generate signed requests to post or retrieve the records;
perform digital signature validation functions, including checking a revocation list via an external agency validation server;
perform maintenance and reporting functions on the records;
the database server wherein signed and validated records are posted for storage and retrieval; and
an interface with an external agency validation server, the Web server operable to establish a secure connection to the external agency validation server.

15. The information exchange system of claim 14, wherein the signer client interface supports PKI certificate management and digital signing functions.

16. The information exchange system of claim 14, wherein the secure connection to the external agency validation server is a Lightweight Directory Access Protocol (LDAP) connection.

17. The information exchange system of claim 14, wherein the first browser comprises a Web browser.

18. The information exchange system of claim 14, wherein the first network comprises the Internet.

19. The information exchange system of claim 14, wherein the secure connection between the external agency validation server and the at least one first server comprises a pinhole access connection.

20. An ordering system, comprising:
a client interface operable to be hosted on an Internet site, the client interface operable to receive an order for a product;
a first server operable to support the client interface and post a signed order to a second server;
the second server, the first server and the second server operable to communicate securely within a secure zone, the second server protected from external communications by the first server, the second server operable to perform signature validation functions, and then securely posts the results back to the first server;
a secured database server wherein signed validated orders are posted for fulfillment and reporting; and
an interface with an external agency validation server, the second server operable to establish an LDAP connection to the external agency validation server.

21. The ordering system of claim 20, wherein signature validation functions comprise checking a revocation list via the external agency validation server
